(19) United States
(12) Patent Application Publication
(10) Pub. No.: US 2011/0202509 A1
(43) Pub. Date: Aug. 18, 2011

(54) EFFICIENT EXTRACTION AND COMPRESSION OF DATA

(75) Inventors: Jerry He, Redmond, WA (US); Florin Olimpiu Folta, Redmond, WA (US); Kishore Kotteri, Bothell, WA (US); Minesh Shilotri, Kirkland, WA (US); Stacey Spears, Sammamish, WA (US); Chuang Gu, Bellevue, WA (US)

(73) Assignee: Microsoft Corporation, Redmond, WA (US)

(21) Appl. No.: 12/706,582

(22) Filed: Feb. 16, 2010

(51) Int. Cl. G06F 17/30

(52) U.S. Cl. 707/693; 707/E17.002

(57) ABSTRACT

A device for dynamically extracting and compressing information for a streaming media asset is provided. One embodiment of the device provides a computing device comprising a processor and memory comprising instructions stored therein that are executable by the processor. The instructions stored in the memory are executable to provide to a requesting computing device dynamically compressed information for a streaming media asset, the dynamically compressed information derived from an information file comprising variable data elements arranged in one or more data fields according to a well-known structure. For example, the instructions are executable to receive from the requesting computing device a request for the compressed information, extract the variable data elements from the information file, compress the variable data elements to form compressed data elements, and send to the requesting computing device a compressed file comprising the compressed data elements.

### BACKGROUND

Streamed data assets may be available for download and playback at various download rates and playback resolutions. When multiple streams are available for the same asset, a description file, or manifest, containing descriptions of these download rates and playback resolutions may be initially downloaded by a playback device to permit the playback device to select a download rate and playback resolution. Further, because the stream characteristics of the asset may change with time, the manifest may be left in an uncompressed format to facilitate updates to the manifest. However, download of the uncompressed manifest may delay playback of the movie, degrading a desirable “instant on” playback of the asset. Some current solutions compress the manifest with a text compression tool prior to download. However, such solutions may still delay playback of the asset in some scenarios where the amount of text to be compressed is large.

### SUMMARY

Accordingly, various embodiments are disclosed herein that relate to the dynamic extraction and compression of data for a streaming media asset. For example, one embodiment provides a computing device comprising a processor and memory, the memory comprising instructions stored therein that are executable by the processor to provide to a requesting computing device dynamically compressed information from an information file comprising variable data elements arranged in one or more data fields according to a well-known structure. For example, the instructions are executable to receive from the requesting computing device a request for the compressed information. Further, the instructions are executable to extract the variable data elements from the information file, compress the variable data elements to form compressed data elements, and send to the requesting computing device a compressed file comprising the compressed data elements.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic view of an embodiment of a dynamic compression and decompression system.

FIG. 2 is a schematic view of an embodiment of a method of operating an embodiment of the dynamic compression and decompression system of FIG. 1.

### DETAILED DESCRIPTION

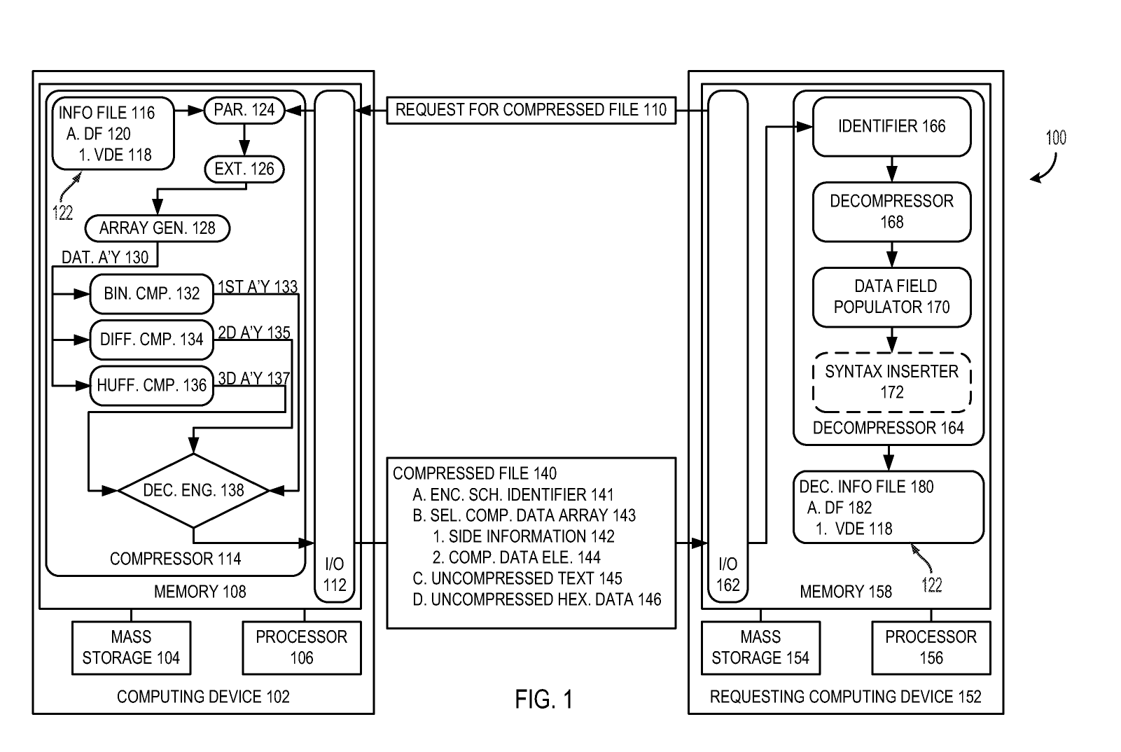

FIG. 1 shows a schematic representation of an embodiment of a dynamic compression and decompression system 100. Dynamic compression and decompression system 100 may be suitable for use in various different environments, including but not limited to a streaming media system. For example, a streaming media system may be configured to provide multiple streams of a single media asset, where each stream for the media asset has a different bit rate to offer a different balance of playback quality and download speed to a playback device. The playback device then may switch between streams to adjust for dynamically-shifting playback variables, such as available network bandwidth and the like, that may affect playback performance of the asset.

In such an environment, to inform the playback device of available streams, a streaming media server may send the playback device a manifest file that contains information regarding all available streams so that the playback device can select a stream to receive. However, as described above, some manifest files may be sufficiently large as to negatively impact a desired “instant-on” playback scenario due to the amount of time spent downloading the manifest. Compression of the manifest prior to downloading may help reduce download times. However, compressing non-variable information (i.e., syntax information in a manifest file) may still result in undesirably long download times for larger manifests.

Therefore, the disclosed embodiments are directed to the extraction of selected information from a file, such as a streaming media asset manifest, that can be efficiently compressed into a smaller size than allowed by the compression of the entire file. The receiving device can then decompress the information and reassemble the file with prior knowledge of the file structure and syntax. Continuing with FIG. 1, dynamic compression and decompression system 100 comprises computing device 102 in operative communication with requesting computing device 152. Computing device 102 comprises mass storage 104, processor 106, and memory 108. Computing device 102 also comprises input/output module 112 and compressor module 114, which may be stored in mass storage 104 and loaded into memory 108 for execution by processor 106. Requesting computing device 152 comprises mass storage 154, processor 156, and memory 158. Requesting computing device 152 further comprises input/output module 162 and decompressor module 164, which may be stored in mass storage 154 and loaded into memory 158 for execution by processor 156.

Computing device 102 and requesting computing device 152 may be any suitable computing devices configured to provide and receive compressed files respectively. For example, in some embodiments, computing device 102 may be a networked computer or a server cloud environment and requesting computing device 152 may be a suitable mobile and/or wireless computing device, a networked computer, a game console, etc. Thus, it will be appreciated that dynamic compression and decompression system 100 may operate by any suitable scheme, such as a server-client scheme, a peer-to-peer scheme, etc.

For illustrative purposes, operation of dynamic compression and decompression system 100 may be divided into three phases. In a first phase, requesting computing device 152 is configured to request a compressed file 140 from computing device 102. In one scenario, compressed file 140 may comprise information about a streaming media asset, including metadata about available streams for the asset. In a second phase, computing device 102 is configured to generate and send compressed file 140 to requesting computing device 152. In a third phase, requesting computing device 152 is configured to decompress compressed file 140 and populate a structured syntax file based at least in part on compressed file 140. In some embodiments, the structured syntax file may be a structured text file, such as an extensible markup language (e.g., XML) or other markup language file, such as a hypertext markup language file (e.g., HTML and subsequent versions thereof, such as HTML5). Additionally or alternatively, in some embodiments, the structured syntax file may be a page description language file or other such file that contains syntax and data. Thus, it will be appreciated that any suitable structured syntax file may be employed. The details of each phase are described in detail below, though it will be appreciated that in other embodiments, tasks maybe organized into other suitable phases and other suitable orders of tasks may be employed.

As introduced above, in the first phase, requesting computing device 152 is configured to request dynamically compressed information from computing device 102. In some embodiments, requesting computing device 152 may be configured to request compressed file 140 from computing device 102 by sending a request for compressed file 110 to computing device 102. In some embodiments, request for compressed file 110 may be a request for a compressed file 140 derived from a structured syntax manifest file for a streaming media asset. Thus, for example, request for compressed file 110 may comprise information in any suitable form that identifies the streaming media asset, and may comprise information about attributes of requesting computing device 152 such as rendering capability, network connection parameters, etc.

In the second phase, computing device 102 is configured to receive a request for dynamically compressed information, which may be embodied by request for compressed file 110; to extract and compress information derived from an information file 116; and to send compressed file 140 to requesting computing device 152. In some embodiments, information file 116 may be a structured syntax manifest file configured to provide metadata about the streaming media asset for use by requesting computing device 152 to decode and render the media asset. For example, in one scenario the streaming media asset may be available as three streams, each having a different bit rate. In this scenario, the structured syntax manifest file may include information about the number of streams, whether each stream is an audio stream or a video stream, a bit rate, a bit width, and/or a pixel resolution for each stream, etc.

Information file 116 comprises variable data elements 118 arranged in one or more data fields 120 according to a well-known structure 122. Variable data elements 118 are configured to represent variable data of information file 116. For example, in the streaming media scenario introduced above, the structured syntax manifest file may have a stream count data field comprising a stream count data element; a stream type data field comprising a stream type data element; a bit rate data field comprising a bit rate data element; a resolution data field comprising a resolution data element, etc. In another scenario where the streaming media asset is subdivided into discrete chunks as a part of a progressive download process, the structured syntax manifest file may include information about the duration of each chunk, the size of each chunk, an ordinal indicator for identifying a temporal position of each chunk within a stream, etc. This information may be organized in the structured syntax manifest file as duration data elements, chunk size data elements, and ordinal data elements, arranged within a duration data field, a chunk size data field, and an ordinal data field, respectively. In some embodiments, variable data elements 118 may comprise integer values. Additionally or alternatively, in some embodiments, variable data elements 118 may comprise floating point values.

Well-known structure 122 may be any suitable hierarchical schema used for structuring information file 116 known by both computing device 102 and requesting computing device 152. In some embodiments, well-known structure 122 may be an XML schema, an HTML schema, a page layout schema, etc. Use of a structure known to both computing device 102 and requesting computing device 152 may beneficially reduce transmission time and/or bandwidth use when transmitting compressed file 140. For example, if the streaming media asset includes multiple layers, etc., the size of compressed file 140 may grow to several megabytes. Mere compression of the whole of information file 116, including structural and syntactical information, by a text compression technique may cause a delay in a start of the movie. In contrast, extracting and compressing variable data elements 118 for inclusion in compressed file 140 may avoid transmission of the structural and syntactical information already known to requesting computing device 152; thus, this approach may beneficially enhance a lossless transmission rate. Further, a resulting simplification of the data to be compressed may beneficially enhance a compression ratio of compressed file 140 by permitting compression by non-text compression techniques, which may further reduce transmission time and/or bandwidth. Consequently, a delay in the start of the streaming media asset may be reduced. Accordingly, it will be appreciated that, in some embodiments, compressed file 140 may not include syntax.

Compressor module 114 is configured to parse variable data elements 118 of information file 116 dynamically; extract variable data elements 118 of information file 116 dynamically; and compress variable data elements 118 of information file 116 dynamically. Parser 124 is configured to parse information file 116 dynamically. It will be appreciated that any suitable parsing method may be employed to parse information file 116.

Extractor 126 is configured to extract variable data elements 118 from the parsed version of information file 116 dynamically. For example, if information file 116 is structured syntax manifest file, parser 124 may read and manipulate the structured syntax manifest file to identify character data and syntax tags. Extractor 126 may further manipulate the structured syntax manifest file to extract variable data elements 118 for later compression to form compressed data elements 144. For example, integer and/or floating point data elements, such as bit width data elements, chunk size data elements, and bit rate data elements may be extracted from a bit width data field, a chunk size data field, and a bit rate data field, respectively. Extractor 126 may also extract information from text and/or hexadecimal fields of information file 116 for inclusion in compressed file 140 as uncompressed text 145 and/or uncompressed hexadecimal data 146. For example, in some embodiments, a text string, a global unique identifier (GUID), and/or a binary large object (BLOB) data element may be included as uncompressed data elements in compressed file 140. Further, in some embodiments, tags for markup language may be included in compressed file 140, which may beneficially enhance population of a decompressed information file 180 at requesting computing device 152. For example, by including tags with compressed file 140, changes or updates to the tags at computing device 102 may be passed through to requesting computing device 152, avoiding changes to the tags at requesting computing device 152.

Array generator 128 of compressor module 114 is configured to arrange dynamically variable data elements 118 of each data field 120 into a data array 130 for that data field before compressing variable data elements 118. In some embodiments, data array 130 may comprise a multi-dimensional data array or a one-dimensional data array. For example, in one scenario, a one-dimensional array may be formed from bit rates of a stream of a streaming media asset, from durations of all segments within the stream, etc. In another scenario, a multi-dimensional array may be formed from the sizes of chunks for a given stream of a streaming media asset, from the quality of all chunks for the given stream, etc.

Compressor module 114 is configured to compress data array 130 dynamically via a plurality of compression techniques in a parallel manner to form a plurality of compressed data arrays, and then to select a selected compressed data array 143 from the plurality of compressed data arrays for inclusion in compressed file 140. In some instances, different compression techniques may have different compression efficiencies according to differences among incoming data arrays. Thus, it will be appreciated that the compressed data arrays resulting from application of different compression techniques may have different file sizes depending upon the specific characteristics of the data in the array, thereby potentially providing for more efficient compression of a plurality of files than the use of a single compression technique.

Referring to the embodiment of FIG. 1, data array 130 is compressed by a first compression technique, represented by a binary coding compression technique 132 in the embodiment of FIG. 1, to form a first compressed data array 133. In a scenario where binary coding compression technique 132 is employed, some embodiments of first compressed data array 133 may comprise a packed representation of an array of integers. For example, if data array 130 represents bit widths for a streaming media asset, data array 130 may be scanned with binary coding compression technique 132 to determine a maximum bit width. Each value of compressed data array 133 may be represented using this maximum bit width. A value representing the maximum bit width may be included as side information 142 of compressed file 140.

Continuing with this example, in FIG. 1, data array 130 also is compressed by a second compression technique, represented by a differential coding compression technique 134 in the embodiment of FIG. 1, to form a second compressed data array 135. In a scenario where differential coding compression technique 134 is employed, some embodiments of second compressed data array 135 may comprise an array of difference values. For example, if data array 130 represents bit widths for a streaming media asset, data array 130 may be scanned with differential coding compression technique 134 to determine the lowest and the highest values, and the difference between all other values of data array 130 and the lowest value of data array 130. Values representing the bit width of the lowest value, the lowest value represented, and the bit width employed to represent the difference between the lowest value and the values of data array 130 may be included as side information 142 of compressed file 140.

Continuing with the example of FIG. 1, data array 130 may also be compressed by a third compression technique, represented by a Huffman coding compression technique 136 in the embodiment of FIG. 1, to form a third compressed data array 137. In a scenario where Huffman coding compression technique 136 is employed, some embodiments of third compressed data array 137 may comprise an array of codes representing symbols generated based on data array 130. For example, if data array 130 represents bit widths for a streaming media asset, data array 130 may be compressed with Huffman coding compression technique 136 to generate an array of symbols and code lengths. Values representing a symbol count, a symbol bit width, a bit width of code lengths, a symbol value for each symbol, and a code length for each symbol may be included as side information 142 of compressed file 140. It will be appreciated that the representative compression techniques listed above are provided for illustrative purposes only and that any suitable compression technique may be employed.

Decision engine 138 of compressor module 114 is configured to select selected compressed data array 143 from one of the plurality of compressed data arrays. The selection made by decision engine 138 may be made in any suitable manner. For example, in some embodiments, decision engine 138 determines a first compression ratio for the first compressed data array 133, a second compression ratio for the second compressed data array 135, and a third compression ratio for the third compressed data array 137. Thus, in the embodiment of FIG. 1, decision engine 138 chooses selected compressed data array 143 from one of the first compressed data array 133, second compressed data array 135, or third compressed data array 137 to be included in compressed file 140 based at least in part on a comparison of the first, second, and third compression ratios (e.g. the most efficiently compressed may be selected).

Continuing with the second phase, compressor module 114 is configured to send compressed file 140 to requesting computing device 152. In some embodiments, an encoding scheme identifier 141 that identifies a decompression technique for decompressing selected compressed data array 143 may be included in compressed file 140. For example, if a binary coding compression technique is used to compress bit width data elements from a bit width data field into a compressed bit width data array, a binary coding scheme identifier may be included in compressed file 140 to alert requesting computing device 152 that a binary coding decompression technique may be used to decompress the compressed bit width data array.

Turning now to the details of the third phase, decompressor module 164 of requesting computing device 152 is configured to receive compressed file 140 and to populate decompressed information file 180 based at least in part on compressed file 140 according to well-known structure 122. Identifier 166 of decompressor module 164 is configured to identify a decompression technique for decompressing compressed file 140. In some embodiments, identifier 166 may identify a decompression technique for selected compressed data array 143 based on encoding scheme identifier 141. For example, in a scenario where compressed file 140 comprises a Huffman compressed data array along with Huffman compression side information and a Huffman encoding scheme identifier for the Huffman compressed data array, identifier 166 may identify a Huffman coding decompression technique for use in decompressing the Huffman compressed data array.

Decompressor 168 of decompressor module 164 is configured to decompress selected compressed data array 143 based on the decompression technique identified by identifier 166. Decompressor 168 may also be configured to read and manipulate side information 142 for selected compressed data array 143 to decompress selected compressed data array 143 into a decompressed data array 169. For example, in the Huffman compressed data array scenario introduced above, decompressor 168 may generate a table of canonical codes for each of the symbols of the Huffman compressed data array based on the decompression technique identified by identifier 166 and based on Huffman compressed data array side information. Decompressor 168 may decode the Huffman compressed data array based in part on the table of canonical codes generated.

Data field populator 170 of decompressor module 164 is configured to arrange variable data elements 118 of decompressed data array 169 into one or more data fields 182 of decompressed information file 180 according to well-known structure 122. It will be appreciated that data field populator 170 may populate data fields according to any suitable structured syntax. In some embodiments, the structured syntax may be in a structured text format, such as an XML or other markup language file, such as a hypertext markup language file (e.g., HTML and subsequent versions thereof, such as HTML5). Additionally or alternatively, in some embodiments, the structured syntax format may be in a page description language format. Thus, it will be appreciated that any suitable structured syntax may be employed to generate decompressed information file 180. For example, in the scenario above, the Huffman compressed data array may comprise bit width data elements extracted from a structured syntax manifest file for a streaming media asset. According to this scenario, data field populator 170 may populate a bit width data field of a corresponding structured syntax manifest file at requesting computing device 152 by arranging the bit width data elements according to well-known structure 122. In some embodiments, decompressed information file 180 may be an XML file.

In some embodiments, data field populator 170 may arrange variable data elements 118 such that variable data elements 118 are associated with structured syntax in a syntax-specific file shell according to well-known structure 122. For example, continuing the scenario above, the corresponding structured syntax manifest file may be a structured syntax shell into which bit width data elements are inserted according to well-known structure 122.

Additionally or alternatively, in some embodiments, structured syntax may be inserted into decompressed information file 180 at syntax inserter 172 of decompressor module 164. Thus, in one scenario, a corresponding structured syntax manifest file may be generated by inserting bit width data elements at data field populator 170 and structured syntax at a structured syntax inserter, each according to well-known structure 122.

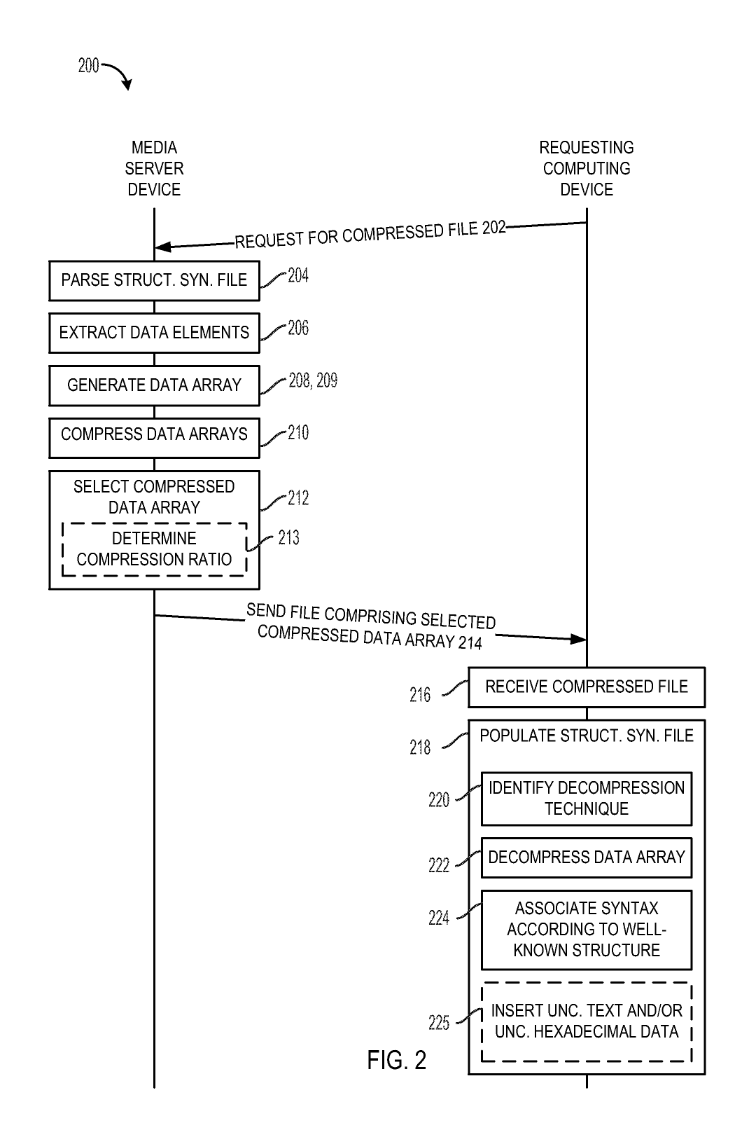

Turning now to FIG. 2, which illustrates an embodiment of a method 200 for dynamically compressing and decompressing information derived from an information file comprising variable data elements arranged in one or more data fields according to a well-known structure. Method 200 may be implemented using the hardware and software components described above in relation to FIG. 1 or via other suitable hardware and software components. For example, FIG. 2 refers to a requesting computing device, which may be a requesting computing device configured to request from a media server device a compressed file derived from a structured syntax manifest file for a streaming media asset, the compressed file comprising variable data elements arranged in one or more compressed data arrays and one or more respective encoding scheme identifiers, and to populate a structured syntax file based at least in part on the compressed file according to a well-known structure. Further, FIG. 2 refers to a media server device, which may be a media server device configured to provide to a requesting computing device a compressed file derived from a structured syntax manifest file for a streaming media asset, the structured syntax manifest file comprising variable data elements arranged in one or more data fields according to a well-known structure. Thus, while FIG. 2 refers to a media server device and a requesting computing device, it will be appreciated that other embodiments of method 200 may be performed on other suitable hardware.

Method 200 comprises, at 202, at the requesting computing device, sending to the media server device a request for the compressed file, and at the media server device, receiving from the requesting computing device a request for the compressed file.

Continuing, at the media server device, method 200 comprises, at 204, parsing the structured syntax manifest file. At 206, method 200 comprises extracting variable data elements from the structured syntax manifest file. At 208, method 200 comprises arranging the variable data elements of a first data field into a data array. In some embodiments, the variable data elements may comprise integer values. Further, in some embodiments, 208 may comprise, at 209, arranging the variable data elements of each data field into a respective data array for that data field. Further still, in some embodiments, the data arrays may comprise a one-dimensional array or a multidimensional array.

At 210, method 200 comprises compressing the data array via a first compression technique to form a first compressed data array and compressing the data array via a second compression technique to form a second compressed data array. In some embodiments, the first compression technique comprises one of a binary coding compression technique, a differential coding compression technique, or a Huffman coding compression technique, and wherein the second compression technique comprise another of a binary coding compression technique, a differential coding compression technique, or a Huffman coding compression technique.

At 212, method 200 comprises selecting one of the first compressed data array or the second compressed data array to be included in the compressed file. In some embodiments, 212 may comprise, at 213, determining a first compression ratio for the first compressed data array and a second compression ratio for the second compressed data array, wherein selecting one of the first compressed data array or the second compressed data array is based at least in part on a comparison of the first compression ratio and the second compression ratio.

Continuing, method 200 comprises, at 214, sending the compressed file comprising the selected compressed data array to the requesting computing device. In some embodiments, the compressed file further may comprise one or more of uncompressed text data and uncompressed hexadecimal data and/or an identifier that identifies a decompression technique for decompressing the selected compressed data array. In some embodiments, 214 may comprise sending the compressed file to the requesting computing device, wherein sending the compressed file further comprises not including syntax in the compressed file.

At the requesting computing device, method 200 comprises, at 216, receiving the compressed file from the media server device. Continuing, method 200 comprises, at 218, populating the structured syntax file based at least in part on the compressed file by, at 220, identifying a decompression technique for each compressed data array based on the respective encoding scheme identifier for each compressed data array; at 222, decompressing the compressed data array into a decompressed data array based on the decompression technique identified; and, at 224, for each decompressed data array, arranging the variable data elements of the decompressed data array into a data field according to the well-known structure such that the variable data elements are associated with structured syntax in the structured syntax file according to the well-known structure. In some embodiments, the decompression technique may comprise one of a binary coding compression technique, a differential coding compression technique, or a Huffman coding compression technique. Additionally or alternatively, in some embodiments, 218 may comprise, at 225, inserting into the structured syntax file one or more of uncompressed text data and uncompressed hexadecimal data included in the compressed file.

It will be appreciated that the computing devices described herein may be any suitable computing device configured to execute the instructions described herein. For example, the computing devices may be a mainframe computer, a personal computer, a laptop computer, a portable data assistant (PDA), a computer-enabled wireless telephone, a networked computing device, a game console, or any other suitable computing device. Further, it will be appreciated that the computing devices described herein may be connected to each other via computer networks, such as the Internet. Further still, it will be appreciated that the computing devices may be connected to a server computing device operating in a network cloud environment.

The computing devices described herein typically include a processor and associated volatile and non-volatile memory, and are typically configured to execute programs stored in non-volatile memory using portions of volatile memory and the processor. As used herein, the term “program” refers to software or firmware components that may be executed by, or utilized by, one or more of the computing devices described herein. Further, the term “program” is meant to encompass individual or groups of executable files, data files, libraries, drivers, scripts, database records, etc. It will be appreciated that computer-readable media may be provided having program instructions stored thereon, which cause the computing device to execute the methods described above and cause operation of the systems described above upon execution by a computing device.

It is to be understood that the configurations and/or approaches described herein are examples, and that these specific embodiments or examples are not to be considered in a limiting sense, because numerous variations are possible. The specific routines or methods described herein may represent one or more of any number of suitable processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A computing device configured to provide to a requesting computing device dynamically compressed information, the dynamically compressed information derived from an information file comprising variable data elements arranged in one or more data fields according to a well-known structure, the computing device comprising:
a processor; and
memory comprising instructions stored therein that are executable by the processor to:
receive from the requesting computing device a request for the dynamically compressed information;
extract the variable data elements from the information file;
compress the variable data elements to form compressed data elements; and
send to the requesting computing device a compressed file comprising the compressed data elements.

2. The computing device of claim 1, wherein the instructions are further executable by the processor to arrange the variable data elements of a first data field into a data array before compressing the variable data elements.

3. The computing device of claim 2, wherein the instructions are further executable by the processor to arrange the variable data elements of each data field into a respective data array for that data field.

4. The computing device of claim 2, wherein the data array comprises a multi-dimensional data array or a one-dimensional data array.

5. The computing device of claim 1, wherein the variable data elements comprise integer values.

6. The computing device of claim 2, wherein the instructions are further executable by the processor to compress the variable data elements by:
compressing the data array via a first compression technique to form a first compressed data array;
compressing the data array via a second compression technique to form a second compressed data array;
determining a first compression ratio for the first compressed data array and a second compression ratio for the second compressed data array;
selecting a selected compressed data array from one of the first compressed data array and the second compressed data array to be included in the compressed file based at least in part on a comparison of the first compression ratio and the second compression ratio; and
wherein the instructions are further executable to send to the requesting computing device an encoding scheme identifier that identifies a decompression technique for decompressing the selected compressed data array.

7. The computing device of claim 6, wherein the first compression technique comprises one of a binary coding compression technique, a differential coding compression technique, or a Huffman coding compression technique, and wherein the second compression technique comprises another of a binary coding compression technique, a differential coding compression technique, or a Huffman coding compression technique.

8. The computing device of claim 1, wherein the compressed file further comprises one or more of uncompressed text data and uncompressed hexadecimal data.

9. The computing device of claim 1, wherein the compressed file does not include syntax.

10. In a media server device configured to provide to a requesting computing device a compressed file derived from a structured syntax manifest file for a streaming media asset, the structured syntax manifest file comprising variable data elements arranged in one or more data fields according to a well-known structure, a method for compressing and sending the compressed file to the requesting computing device, the method comprising:
receiving from the requesting computing device a request for the compressed file;
extracting variable data elements from the structured syntax manifest file;
arranging the variable data elements of a first data field into a data array;
compressing the data array via a first compression technique to form a first compressed data array;
compressing the data array via a second compression technique to form a second compressed data array;
selecting one of the first compressed data array or the second compressed data array to be included in the compressed file; and
sending the compressed file comprising the selected compressed data array to the requesting computing device.

11. The method of claim 10, wherein the first compression technique comprises one of a binary coding compression technique, a differential coding compression technique, or a Huffman coding compression technique, and wherein the second compression technique comprises another of a binary coding compression technique, a differential coding compression technique, or a Huffman coding compression technique.

12. The method of claim 10, wherein the compressed file further comprises one or more of uncompressed text data and uncompressed hexadecimal data and/or an identifier that identifies a decompression technique for decompressing the selected compressed data array.

13. The method of claim 10, wherein sending the compressed file further comprises not including syntax in the compressed file.

14. The method of claim 10, wherein the data array comprises a one-dimensional array or a multidimensional array.

15. The method of claim 10, wherein the variable data elements comprise integer values.

16. The method of claim 10, further comprising determining a first compression ratio for the first compressed data array and a second compression ratio for the second compressed data array, wherein selecting one of the first compressed data array or the second compressed data array is based at least in part on a comparison of the first compression ratio and the second compression ratio.

17. The method of claim 10, further comprising arranging the variable data elements of each data field into a respective data array for that data field.

18. In a requesting computing device configured to request from a media server device a compressed file derived from a structured syntax manifest file for a streaming media asset, the compressed file comprising variable data elements arranged in one or more compressed data arrays and one or more respective encoding scheme identifiers, and to populate a structured syntax file based at least in part on the compressed file according to a well-known structure, a method for requesting the compressed file from the media server device and populating the structured syntax file, the method comprising:
sending to the media server device a request for the compressed file;
receiving the compressed file from the media server device;
populating the structured syntax file based at least in part on the compressed file by
identifying a decompression technique for each compressed data array based on the respective encoding scheme identifier,
for each compressed data array, decompressing the compressed data array into a decompressed data array based on the decompression technique identified, and
for each decompressed data array, arranging the variable data elements of the decompressed data array into a data field according to the well-known structure such that the variable data elements are associated with syntax in the structured syntax file according to the well-known structure.

19. The method of claim 18, wherein the decompression technique comprises one of a binary coding compression technique, a differential coding compression technique, or a Huffman coding compression technique.

20. The method of claim 18, further comprising inserting into the structured syntax file one or more of uncompressed text data and uncompressed hexadecimal data included in the compressed file.
